(19) United States
(12) Patent Application Publication
(10) Pub. No.: US 2006/0029799 A1
(43) Pub. Date: Feb. 9, 2006

(54) Adhesive delivery of fluoroether repellents

(75) Inventors: John M. Sebastian, St. Paul, MN (US); Stefan H. Gryska, Woodbury, MN (US); Thomas P. Klun, Lakeland, MN (US); Chetan P. Jariwala, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/910,228

(22) Filed: Aug. 3, 2004

(51) Int. Cl. B32B 7/12

(52) U.S. Cl. 428/355 R; 428/343

(57) ABSTRACT

A repellent article is disclosed comprising a layer of a thermoplastic polymer, and an adhesive layer having a fluorochemical repellent additive dispersed therein. The additive migrates from the adhesive layer to the thermoplastic polymer layer, rendering it oil- and/or water repellent.

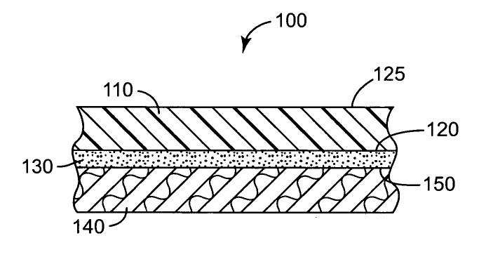

### FIELD OF THE INVENTION

The present invention relates to a repellent article comprising a layer of a thermoplastic polymer, and an adhesive layer having a fluorochemical repellent additive dispersed therein. The present invention also relates to a method of making such articles. The repellent article is useful, for example, in medical or surgical drapes, garments, protective films and barriers, carpet backings and outdoor fabrics and films.

### BACKGROUND OF THE INVENTION

It is known in the art to modify the surface properties of a thermoplastic polymer by adding a compound during the extrusion of the thermoplastic polymer. For example, WO 92/18569 and WO 95/01396 describe fluorochemical additives for use in the extrusion of thermoplastic polymers to prepare films and fibers with repellency properties. However, many fluorochemicals cannot be directly compounded and extruded as a melt because of the low decomposition temperatures of the fluorochemical repellent additives. In other cases, the fluorochemical repellent additives may interfere with polymer nucleation, or may degrade the physical properties of the thermoplastic polymer during processing.

It is further known to provide coatings of various fluorochemicals on polymer films to provide repellency properties. Such coatings add an additional, and often costly manufacturing step, and the resulting coatings are subject to wear and environmental degradation.

### SUMMARY

Accordingly, there is a need for a thermoplastic polymer articles with a repellent surface. There is a further need to provide such repellent surfaces that will avoid problems associated with compounding in the melt, and coating degradation. As will be set forth in detail below, the present invention solves this problem by dispersing a fluorochemical repellent additive in an adhesive layer bonded to the thermoplastic polymer layer of the article. The thermoplastic polymer layer may be in the form of a nonporous film, a membrane or a fibrous layer, such as a woven or nonwoven fabric.

The present invention solves a problem of the art by providing a reservoir for fluorochemical repellent additives in an adhesive layer bonded, adhered, or otherwise affixed to a thermoplastic polymer layer, in order that the surface(s) of the polymer layer is rendered repellent via migration of such fluorochemical repellent additives from the adhesive into the polymer layer, and that the additive lost by degradation may be renewed.

The fluorochemical repellent additive comprises the reaction product of:
a) a fluorinated ether according to the formula:
   R_{f}-Q-Tₖ (I)
   wherein R_{f} represents a perfluoroheteroalkyl group, Q represents a chemical bond or a divalent or trivalent organic linking group, T represents an isocyanate-reactive functional group, and k is 1 or 2;
b) a polyisocyanate; and
c) optionally one or more co-reactants having an isocyanate-reactive functional group.

The present invention provides a repellent article comprising a polymeric layer having a first repellent surface and a second surface having an adhesive layer bonded thereto, said adhesive layer comprising sufficient fluorochemical repellent additive dispersed therein which migrates to said first surface of said polymeric layer, rendering it repellent to oil and/or water. The fluorochemical repellent additive is used in an amount sufficient to provide the desired level of repellency to the thermoplastic polymer layer (upon migration). Typically, the fluorochemical repellent additive will be added in an amount sufficient to provide the thermoplastic polymer layer with an advancing water contact angle of 85° or greater and/or an advancing oil contact angle of 50° or greater.

While a range of fluorochemical repellent additive concentrations may be used in the practice of the invention, generally the adhesive layer will contain at least 1 wt. % up to and including 45 wt. % of at least one fluorochemical repellent additive fluorochemical repellent additive, based on the total weight of the adhesive layer. Preferably the pressure sensitive adhesive layer comprises from at least 3 to 15 wt. % of repellent additive, based on the total weight of the adhesive layer.

In another aspect, the present invention provides a method of making a repellent article comprising contacting a pressure sensitive adhesive with a major surface of a first thermoplastic polymer layer, wherein the adhesive comprises from 1 weight percent up to and including 45 weight percent of at least one fluorochemical repellent additive based on the total weight of the adhesive.

It will be understood that in connection with the present invention the use of the term “dispersed therein” denotes merely the initial presence of the fluorochemical repellent additive in the adhesive layer without limitation as to where the fluorochemical repellent additive may subsequently migrate. Thus the fluorochemical repellent additive may be initially uniformly dispersed in the bulk of the adhesive or may have migrated to the surface of the thermoplastic polymer layer.

As used herein, “repellent” or “repellency” is used only to refer to the surface characteristics of the thermoplastic polymer layer, i.e., that it is a measure of a substrate's resistance to wetting by oil and/or water and or adhesion of particulate soil. Repellency may be measured by the test methods described herein. Accordingly, a thermoplastic polymer layer may be referred to as repellent whether or not the layer is impermeable or permeable to aqueous solutions.

One aspect of the present invention is a method for providing a repellent article comprising a thermoplastic polymer layer and an adhesive layer, comprising the steps of: (a) dispersing into an adhesive layer at least one fluorochemical repellent additive that provides a repellent surface to the polymer layer (upon migration of the additive); and (b) adhering the adhesive to a thermoplastic polymer layer such that the adhesive layer provides a fluorochemical repellent additive reservoir for the polymer layer. A feature of the present invention is the ability to provide a reservoir of fluorochemical repellent additive in an adhesive contacting the polymer layer to provide repellency over a period of time.

Unexpectedly, the method of the present invention not only provides a repellent surface to a polymer layer adjoining the adhesive, but also, when the reservoir adhesive adjoins a first layer, other layers in a composite article. More specifically, if the reservoir adhesive adjoins a first layer, the fluorochemical repellent additive may migrate through the first layer into additional layers in a multilayer article. Significantly, the fluorochemical repellent additives in a reservoir may migrate across two different layers of two different materials to render a third layer repellent. Thus, another advantage of the present invention is the ability to use multilayer films that might not contain any fluorochemical repellent additives yet are provided a repellent surface via fluorochemical repellent additives that have migrated from an adhesive layer, through intermediate layers.

Another aspect of the present invention is a thermoplastic polymer layer that is rendered repellent by an adjoining adhesive delivery system for fluorochemical repellent additives that provides a repellent surface to the adjoining thermoplastic polymer layer, and wherein the thermoplastic polymer layer itself initially has some degree of oleo- or hydrophobicity, prior to fluorochemical repellent additive migration. In another aspect, the adhesive delivery system enhances the repellency of a thermoplastic polymer layer.

“Adhesive delivery system” means the use of adhesive to provide a reservoir for fluorochemical repellent additives and to facilitate the migration of such fluorochemical repellent additives from the adhesive layer into adjoining thermoplastic polymer layer(s). Use of this adhesive delivery system eliminates problems that occur in the two most common methods used for providing a repellent surface to thermoplastic polymers: extrusion and coating. Fluorochemical repellent additives frequently cannot be directly compounded and extruded as a melt because of the low decomposition temperatures of the fluorochemical repellent additives. In other cases, the fluorochemical repellent additives may interfere with polymer nucleation, or may degrade the physical properties of the thermoplastic polymer during processing.

Coating methods to provide a repellent surface also have some limitations. First of all, the extra step required in film preparation is expensive, time consuming and involves safety and environmental issues. Many of the solvents used for coating are flammable liquids or have exposure limits that require special production facilities. Furthermore the quantity of fluorochemical repellent additive is limited by the solubility in the coating solvent and the thickness of the coating. Again, incorporation of fluorochemical repellent additives into the adhesive can solve these problems. The “adhesive delivery system” of the present invention solves these problems.

Unless otherwise stated, the following terms used in the specification and claims have the meanings given below:

“Alkyl” means a linear or branched saturated monovalent hydrocarbon radical having from one to about twelve carbon atoms or a branched saturated monovalent hydrocarbon radical, e.g., methyl, ethyl, 1-propyl, 2-propyl, pentyl, and the like.

“Alkylene” means a linear saturated divalent hydrocarbon radical having from one to about twelve carbon atoms or a branched saturated divalent hydrocarbon radical, e.g., methylene, ethylene, propylene, 2-methylpropylene, pentylene, hexylene, and the like.

“Aliphatic” means a linear or branched saturated mono- or polyvalent hydrocarbon radical.

“Isocyanate-reactive functional group” means a functional group that is capable of reacting with an isocyanate group, such as hydroxyl, amino, thiol, etc.

“Perfluorinated group” means an organic group wherein all or essentially all of the carbon bonded hydrogen atoms are replaced with fluorine atoms, e.g. perfluoroalkyl, and the like.

“Polyisocyanate” means a compound containing an average of greater than one, preferably two or more isocyanate groups, —NCO, attached to a multivalent organic group, e.g. hexamethylene diisocyanate, the biuret and isocyanurate of hexamethylene diisocyanate, and the like.

“Alkyl” means a linear saturated monovalent hydrocarbon radical having from one to about twelve carbon atoms or a branched saturated monovalent hydrocarbon radical having from three to about twelve carbon atoms, e.g., methyl, ethyl, 1-propyl, 2-propyl, pentyl, and the like.

“Alkylene” means a linear saturated divalent hydrocarbon radical having from one to about twelve carbon atoms or a branched saturated divalent hydrocarbon radical having from three to about twelve carbon atoms, e.g., methylene, ethylene, propylene, 2-methylpropylene, pentylene, hexylene, and the like.

“Heteroalkyl” has essentially the meaning given above for alkyl except that one or more heteroatoms (i.e. oxygen, sulfur, and/or nitrogen) may be present in the alkyl chain, these heteroatoms being separated from each other by at least one carbon, e.g., CH₃CH₂OCH₂CH₂—, CH₃CH₂OCH₂CH₂OCH(CH₃)CH₂—, C₄F₉CH₂CH₂SCH₂CH₂—, and the like.

“Heteroalkylene” has essentially the meaning given above for alkylene except that one or more heteroatoms (i.e. oxygen, sulfur, and/or nitrogen) may be present in the alkylene chain, these heteroatoms being separated from each other by at least one carbon, e.g., —CH₂OCH₂O—, —CH₂CH₂OCH₂CH₂—, —CH₂CH₂N(CH₃)CH₂CH₂—, —CH₂CH₂SCH₂CH₂—, and the like.

“Perfluoroalkyl” has essentially the meaning given above for “alkyl” except that all or essentially all of the hydrogen atoms of the alkyl radical are replaced by fluorine atoms and the number of carbon atoms is from 1 to about 12, e.g. perfluoropropyl, perfluorobutyl, perfluorooctyl, and the like.

“Perfluoroalkylene” has essentially the meaning given above for “alkylene” except that all or essentially all of the hydrogen atoms of the alkylene radical are replaced by fluorine atoms, e.g., perfluoropropylene, perfluorobutylene, perfluorooctylene, and the like “Perfluoroheteroalkyl” has essentially the meaning given above for “heteroalkyl” except that all or essentially all of the hydrogen atoms of the heteroalkyl radical are replaced by fluorine atoms and the number of carbon atoms is from 3 to about 100, e.g. CF₃CF₂OCF₂CF₂—, CF₃CF₂O(CF₂CF₂O)₃CF₂CF₂—, C₃F₇O(CF(CF₃)CF₂O)ₘCF(CF₃)CF₂ where m is from about 10 to about 30, and the like.

“Perfluoroheteroalkylene” has essentially the meaning given above for “heteroalkylene” except that all or essentially all of the hydrogen atoms of the heteroalkylene radical are replaced by fluorine atoms, and the number of carbon atoms is from 3 to about 100, e.g., —CF₂OCF₂—, —CF₂O(CF₂O)ₙ(CF₂CF₂O)ₘCF₂—, and the like.

“Repellency” is a measure of a treated substrate's resistance to wetting by oil and/or water and or adhesion of particulate soil. Repellency may be measured by the test methods described herein.

### BRIEF DESCRIPTION OF THE DRAWING

The drawing is an exemplary cross-sectional side view of a repellent article according to the present invention.

### DETAILED DESCRIPTION

Referring now to the FIGURE, exemplary repellent article 100 comprises thermoplastic polymer layer 110 having major surfaces 120 and 125. Pressure sensitive adhesive layer 130 contacts major surface 120, and optionally contacts major surface 150 of substrate 140. Pressure sensitive adhesive layer 130 comprises at least one pressure sensitive adhesive and at least 1 weight percent, on a total weight basis of the pressure sensitive adhesive layer, of at least one fluorochemical repellent additive. In some embodiments of the present invention, substrate 140 may be, for example, a release liner.

Without wishing to be bound by theory, it is believed that fluorochemical repellent additive in the adhesive layer gradually migrates from the pressure sensitive adhesive layer into the thermoplastic polymer layer. During use, exposure or storage, fluorochemical repellent additive that has diffused to the thermoplastic polymer layer may be depleted. By providing a gradual release of fluorochemical repellent additive from the adhesive reservoir, the thermoplastic polymer layer may be provided with a continuous supply of fluorochemical repellent additive. It is believed that the migration of the fluorochemical repellent additive from the adhesive layer through the thermoplastic polymer layer is a diffusion process, and therefore the T_{g} of the adhesive layer and thermoplastic polymer layers are preferably at or below 25° C., and is more preferably below about 0° C. Polymers in the glassy state are generally less permeable than those in the rubbery state, so polymers in the rubbery state are particularly useful. Heating the article may enhance the migration of the fluorochemical repellent additive.

If it is assumed that Fick's Second Law applies, such that there is an effective diffusion coefficient (D) that is not concentration dependent, then for 1 dimensional diffusion of a species into a semi-infinite medium, the solution of
∂C/∂t=D(∂²C/∂x²) [Fick's 2^{nd} law]
where C=C₀, x=0, t>0 [boundary condition]
and C=0, x>0, t=0 [initial condition]
   is found to be
   C=C₀(ERFC[x/(4Dt)^{1/2}]),
   where C is the concentration of the diffusing species, t is time, x is the coordinate of the diffusion direction, and ERFC is the complementary error function. Reference may be made to The Mathematics of Diffusion, 2^{nd} Edition, J. Crank, Clarendon Press, Oxford, 1975.

Preferably, the Fick's diffusion constant of the additive, D (which is dependent on the fluorochemical repellent additive, the polymer and temperature) is greater than 0.1×10⁻¹⁰ cm²/s, preferentially greater than 10×10⁻¹⁰ cm²/s and most preferentially greater than 100×10⁻¹⁰ cm²/s at 25° C. in the thermoplastic polymer layer. It is expected that articles having diffusion constants in this range would experience rates of diffusion such that the concentration of the fluorochemical repellent additive reaches a level about equal to half of its initial value in the adhesive (i.e. C=C₀/2 from above) within a few days. For liquid fluorochemical repellent additives, it may be preferred for the concentration to be above the solubility limit in the adhesive. Above this limit the diffusion will be enhanced.

The fluorochemical repellent additives are nonionic, hydrophobic and oleophobic. Useful additives comprise a perfluoroheteroalkyl group and an oleophilic moiety, and will phase separate in the adhesive layer upon cooling, or at room temperature, in the absence or solvent or other surfactants. Useful additives further have an advancing water contact angle of 85° or greater and an advancing oil (hexadecane) contact angle of 50° or greater. Advancing contacts angles may be measured using, for example, a CAHN Dynamic Contact Angle Analyzer, Model DCA 322, by the test methods described herein.

The fluorochemical repellent additive comprises the reaction product of:
a) a fluorinated ether according to the formula:
   R_{f}-Q-Tₖ (I)
   wherein R_{f} represents a perfluoroheteroalkyl group, Q represents a chemical bond or a divalent or trivalent organic linking group, T represents an isocyanate-reactive functional group, and k is 1 or 2;
b) a polyisocyanate; and
c) optionally one or more co-reactants having an isocyanate-reactive functional group.

The fluorochemical repellent additive is obtainable by reacting an polyisocyanate component and optional co-reactants with a fluorinated ether according to formula (I) that has an isocyanate reactive functional group:
R_{f}-Q-Tₖ (I)
wherein R_{f} represents a monovalent perfluoroheteroalkyl group, Q represents a chemical bond or a divalent or trivalent non-fluorinated organic linking group, T represents an isocyanate reactive functional group, and k is 1 or 2. R_{f} may be a monoether or a polyether, i.e. a perfluoroalkoxyalkylene group or a monovalent perfluoropolyether group.

The perfluoroheteroalkyl group, R_{f}, of the fluorinated ether of formula (I) preferably corresponds to the formula:
R_{f}¹—O—(R_{f}²)ₓ—(R_{f}³)_{y}— (II)
wherein R¹_{f} represents a perfluoroalkyl group, R_{f}² represents a perfluorinated polyalkyleneoxy group consisting of perfluoroalkyleneoxy groups having 1 to 4 perfluorinated carbon atoms or a mixture of such perfluoroalkyleneoxy groups, R_{f}³ represents a perfluoroalkylene group, x is 0 or 1, y is 0 or 1, with the proviso that at least one of x or y is 1. The perfluoroalkyl group R_{f}¹ in formula (II) may be linear or branched and may comprise 1 to 10 carbon atoms, preferably 1 to 6 carbon atoms. A typical perfluoroalkyl group is CF₃—CF₂-CF₂—. R_{f}³ may be a linear or branched perfluoroalkylene group that will typically have 1 to 6 carbon atoms. For example, R_{f}³ is —CF₂— or —CF(CF₃)—. Preferable the molecular weight of the fluorinated ether of Formula II is at least 750 g/mol. Examples of perfluoroalkylene oxy groups of perfluorinated polyalkyleneoxy group R_{f}² include: —CF₂—CF₂-O—, —CF(CF₃)—CF₂—O—, —CF₂—CF(CF₃)—O—, —CF₂—CF₂-CF₂—O—, —CF₂—O—, —CF(CF₃)—O—, and —CF₂—CF₂-CF₂—CF₂-O—.

The perfluoroalkyleneoxy group may be comprised of the same perfluoroalkylene oxy units or of a mixture of different perfluoroalkylene oxy units. When the perfluoroalkyleneoxy group is composed of different perfluoroalkylene oxy units, they can be present in a random configuration, alternating configuration or they can be present as blocks. Typical examples of perfluoroalkyleneoxy groups include: —[CF₂—CF₂-O]ᵣ-; —[CF(CF₃)—CF₂—O]ₙ-; —[CF₂CF₂—O]ᵢ-[CF₂O]ⱼ— and -[CF₂—CF₂-O]ₗ-[CF(CF₃)—CF₂—O]ₘ—; wherein r is an integer of 4 to 25, n is an integer of 3 to 25 and i, l, m and j each are integers of 2 to 25. A preferred perfluorinated polyether group that corresponds to formula (II) is CF₃—CF₂—CF₂—O—[CF(CF₃)—CF₂O]ₙ—CF(CF₃)— wherein n is an integer of 3 to 25. This perfluoropolyether group has a molecular weight of 783 when n equals 3 and can be derived from an oligomerization of hexafluoropropylene oxide. Such perfluorinated polyether groups are preferred in particular because of their benign environmental properties.

Examples of linking groups Q include organic groups that comprise aromatic or aliphatic groups that may be interrupted by O, N or S and that may be substituted, alkylene groups, oxy groups, thio groups, urethane groups, carboxy groups, carbonyl groups, amido groups, oxyalkylene groups, thioalkylene groups, carboxyalkylene and/or an amidoalkylene groups. Q may include —(CH₂)ₖ—, —(CH₂)ₖ—O—C(O)—, —(CH₂)ₖ—NR²—C(O)—, —(CH₂)ₖ—C(O)—O—, —(CH₂)ₖ—C(O)—NR²—, —SO₂ N(R²)(CH₂)ₖ—, —(CH₂)ₖ—, —CON(R²)(CH₂)ₖ-, —(CH₂)ₖSO₂N(R²)(CH₂)ₖ—, —(CH₂)ₖ—O—C(O)NR²—, or —(CH₂)ₖ—NR²—C(O)—NR²—, where R² is hydrogen, a phenyl group or is a short chain substituted or unsubstituted alkyl group, preferably a methyl or ethyl group and where each k is independently an integer from 0 to about 20. It will be understood that the above-depicted Q groups are non-directional, e.g. —(CH₂)ₖ—O—C(O)— and —C(O)—O)—(CH₂)ₖ— are contemplated. Further, one or more of the depicted hydrogen atoms may be substituted by additional isocyanate-reactive “T” groups. Examples of functional groups T include thiol, hydroxy and amino groups.

In a particular embodiment, the fluorinated polyether corresponds to the following formula (III):
R_{f}¹-[CF(CF₃)—CF₂O]ₙ—CF(CF₃)-Q-Tₖ (III)
wherein R_{f}¹ represents a perfluorinated alkyl group, e.g., a linear or branched perfluorinated alkyl group having 1 to 6 carbon atoms, n is an integer of 3 to 25, Q is a chemical bond or an organic divalent or trivalent linking group for example as mentioned for the linking group Q above, k is 1 or 2 and T represents an isocyanate reactive group and each T may be the same or different. Particularly preferred compounds are those in which R¹_{f} represents CF₃CF₂CF₂—. In accordance with a particular embodiment, the moiety -Q-Tₖ is a moiety of the formula —CO—X-R^{a}(OH)ₘ wherein m is 1 or 2, X is O or NR^{b} with R^{b} representing hydrogen or an alkyl group of 1 to 4 carbon atoms, and R^{a} is an alkylene of 1 to 15 carbon atoms.

Representative examples of the moiety-Q-Tk in above formula (III) include: —CONR^{c}-CH₂CHOHCH₂OH, wherein R^{c} is hydrogen or an alkyl group of for example 1 to 4 carbon atoms; —CONH-dihydroxyphenyl; —CH₂OCH₂CHOHCH₂OH; —COOCH₂CHOHCH₂OH; and —CONR^{d}-(CH₂)ₘOH, where Rd is hydrogen or an alkyl group of 1 to 6 carbons and m is 1 to 10.

Compounds according to formula (III) can for example be obtained by oligomerization of hexafluoropropylene oxide which results in a perfluoropolyether carbonyl fluoride. This carbonyl fluoride may be converted into an acid, ester or alcohol by reactions well known to those skilled in the art. The carbonyl fluoride or acid, ester or alcohol derived therefrom may then be reacted further to introduce the desired isocyanate reactive groups according to known procedures. For example, U.S. Pat. No. 6,127,498 or U.S. Pat. No. 3,536,710 describe suitable methods to produce compounds according to formula (III) having desired moieties -Q-Tₖ.

Further details concerning the materials and procedures for the preparation of reactive fluorinated polyethers can be found in, for example, U.S. Pat. No. 3,242,218 (Miller); U.S. Pat. No. 3,322,826 (Moore); U.S. Pat. No. 3,250,808 (Moore et al.); U.S. Pat. No. 3,274,239 (Selman); U.S. Pat. No. 3,293,306 (Le Bleu et al.); U.S. Pat. No. 3,810,874 (Mitsch et al.); U.S. Pat. No. 3,544,537 (Brace); U.S. Pat. No. 3,553,179 (Bartlett); U.S. Pat. No. 3,864,318 (Caporiccio et al.); U.S. Pat. No. 4,321,404 (Williams et al.), U.S. Pat. No. 4,647,413 (Savu); U.S. Pat. No. 4,818,801 (Rice et al.); U.S. Pat. No. 4,472,480 (Olson); U.S. Pat. No. 4,567,073 (Larson et al.); U.S. Pat. No. 4,830,910 (Larson); and U.S. Pat. No. 5,306,758 (Pellerite), the disclosures of which are incorporated herein by reference.

It will be evident to one skilled in the art that a mixture of fluorinated ethers according to formula (I) may be used to prepare the fluorochemical repellent additive. Generally, the method of making the fluorinated ether according to formula (I) will result in a mixture of fluorinated ethers that have different molecular weights and such a mixture can be used as such to prepare the fluorochemical repellent additive. In a preferred embodiment, such a mixture of fluorinated ether compounds according to formula (I) is free of fluorinated ether compounds having a perfluorinated polyether moiety having a molecular weight of less than 750 g/mol or alternatively the mixture contains fluorinated polyether compounds having a perfluorinated polyether moiety having a molecular weight of less than 750 g/mol in an amount of not more than 10% by weight relative to total weight of fluorinated polyether compounds, preferably not more than 5% by weight and most preferably not more than 1% by weight.

The polyisocyanate component for making the fluorochemical repellent additive is selected from a polyisocyanate having an average of greater than one, preferably two or more isocyanate groups, —NCO, attached to a multivalent organic group. The polyisocyanate compound may be aliphatic or aromatic and is conveniently a non-fluorinated compound. Generally, the molecular weight of the polyisocyanate compound will be not more than 1500 g/mol.

Examples include hexamethylenediisocyanate, 2,2,4-trimethyl-1,6-hexamethylenediisocyanate, and 1,2-ethylenediisocyanate, dicyclohexylmethane-4,4′-diisocyanate, aliphatic triisocyanates such as 1,3,6-hexamethylenetriisocyanate, cyclic trimer of hexamethylenediisocyanate and cyclic trimer of isophorone diisocyanate (isocyanurates); aromatic polyisocyanate such as 4,4′-methylenediphenylenediisocyanate, 4,6-di-(trifluoromethyl)-1,3-benzene diisocyanate, 2,4-toluenediisocyanate, 2,6-toluene diisocyanate, o, m, and p-xylylene diisocyanate, 4,4′-diisocyanatodiphenylether, 3,3′-dichloro-4,4′-diisocyanatodiphenylmethane, 4,5′-diphenyldiisocyanate, 4,4′-diisocyanatodibenzyl, 3,3′-dimethoxy-4,4′-diisocyanatodiphenyl, 3,3′-dimethyl-4,4′-diisocyanatodiphenyl, 2,2′-dichloro-5,5′-dimethoxy-4,4′-diisocyanato diphenyl, 1,3-diisocyanatobenzene, 1,2-naphthylene diisocyanate, 4-chloro-1,2-naphthylene diisocyanate, 1,3-naphthylene diisocyanate, and 1,8-dinitro-2,7-naphthylene diisocyanate and aromatic triisocyanates such as polymethylenepolyphenylisocyanate. Still further isocyanates that can be used for preparing the fluorochemical repellent additive include alicyclic diisocyanates such as 3-isocyanatomethyl-3,5,5-trimethylcyclohexylisocyanate; aromatic tri-isocyanates such as polymethylenepolyphenylisocyanate (PAPI); cyclic diisocyanates such as isophorone diisocyanate (IPDI). Also useful are isocyanates containing internal isocyanate-derived moieties such as biuret-containing tri-isocyanates such as that available from Bayer as DESMODUR™ N-100, isocyanurate-containing tri-isocyanates such as that available from Huls AG, Germany, as IPDI-1890, and azetedinedione-containing diisocyanates such as that available from Bayer as DESMODUR™ TT. Also, other di- or tri-isocyanates such as those available from Bayer as DESMODUR™ L and DESMODUR™ W, tri-(4-isocyanatophenyl)-methane (available from Bayer as DESMODUR™ R) and DDI 1410 (available from Henkel) are suitable.

In a preferred embodiment, the fluorochemical repellent additive further comprises the reaction product of a perfluoroalkyl functional compound comprising a perfluoroalkyl group and one or more isocyanate reactive functional groups as the optional co-reactant. The perfluoroalkyl group contains 3 to 18 carbon atoms but preferably has 3 to 6 carbon atoms, in particular a C₄F₉— group. By including perfluoroalkyl groups, in particular C₄F₉-groups in the fluorinated ether compound, one can improve the repellency of the repellent article. The perfluoroalkyl groups may further improve the solubility and/or dispersibility of the fluorinated polyether compound in the adhesive.

Preferred perfluoroalkyl functional compound co-reactants will correspond to the formula:
(R_{f}⁴)ₓ-L-(Y)_{y} (IV)
wherein R_{f}⁴ represents a perfluoroalkyl group having 3 to 6 carbon atoms, L represents a non-fluorinated organic divalent or multi-valent linking group such as for example organic groups that comprise alkylene, carboxy, sulfonamido, carbonamido, oxy, alkyleneoxy, thio, alkylenethio and/or arylene. Y represents an isocyanate-reactive functional group, such as for example hydroxy, amino or thiol, x is an integer of 1 to 20, for example between 2 and 10, and y is an integer of 1 to 3, and is preferably 1. According to a particular embodiment, R_{f}⁴ is C₄F₉—, x is 1, and y is 1.

Compounds of Formula IV may be selected from fluorochemical alcohols. Representative fluorine-containing alcohols include 2-(N-ethylperfluorobutanesulfonamido)ethanol; 2-(N-ethylperfluorobutanesulfonamido)ethanol; 2-(N-methylperfluorobutanesulfonamido)propanol; N-methyl-N-(4-hydroxybutyl)perfluorohexanesulfonamide; 1,1,2,2-tetrahydroperfluorooctanol; 1,1-dihydroperfluorooctanol; and the like; and mixtures thereof. It will be understood, with respect to the above lists, that the terminal hydroxyl may be replaced with other isocyanate-reactive functional groups (amines, thiols, etc.).

Compounds according to formula (IV) in which x is 2 or more can be conveniently prepared through the polymerization of a perfluoroaliphatic compound having a polymerizable group in the presence of a functionalized chain transfer agent. Examples of such polymerizable perfluoroaliphatic compounds include those according to the formula:
R_{f}⁴-Q³-C(R²)═CH₂ (V)
wherein R_{f}⁴ is a perfluoroaliphatic group of 3 to 5 or 6 carbon atoms, preferably C₄F₉-, R² is hydrogen or a lower alkyl of 1 to 4 carbon atoms and Q³ represents a non-fluorinated organic divalent linking group. The linking group Q³ links the perfluoroaliphatic group to the free radical polymerizable group. Linking group Q³ is generally non-fluorinated and preferably contains from 1 to about 20 carbon atoms. Q³ can optionally contain oxygen, nitrogen, or sulfur-containing groups or a combination thereof, and Q³ is free of functional groups that substantially interfere with free-radical polymerization (e.g., polymerizable olefinic double bonds, thiols, and other such functionality known to those skilled in the art). Examples of suitable linking groups Q³ include straight chain, branched chain or cyclic alkylene, arylene, aralkylene, sulfonyl, sulfoxy, sulfonamido, carbonamido, carbonyloxy, urethanylene, ureylene, and combinations thereof such as sulfonamidoalkylene, such as those describe for the Q group of Formula I supra.

Specific examples of fluorinated aliphatic group containing monomers include:
CF₃CF₂CF₂CF₂CH₂CH₂OCOCR²═CH₂; CF₃(CF₂)₃CH₂OCOCR²═CH₂;
CF₃(CF₂)₃SO₂N(CH₃)CH₂CH₂OCOCR²═CH₂;
CF₃(CF₂)₃SO₂N(C₂H₅)CH₂CH₂OCOCR²═CH₂;
CF₃(CF₂)₃SO₂N(CH₃)CH₂CH(CH₃)OCOCR²═CH₂;
(CF₃)₂CFCF₂SO₂N(CH₃)CH₂CH₂OCOCR²═CH₂; and C₆F₁₃C₂H₄OOC—CR²═CH₂
   wherein R² is hydrogen or a lower alkyl of 1 to 4 carbon atoms.

Examples of suitable chain transfer agents include compounds those functional chain transfer agents having isocyanate-reactive functional groups such as amino groups, hydroxy and acid groups. Specific examples of functional chain transfer agents include 2-mercaptoethanol, mercaptoacetic acid, 2-mercaptobenzoic acid, 3-mercapto-2-butanol, 2-mercaptosulfonic acid, 2-mercaptoethylsulfide, 2-mercaptonicotinic acid, 4-hydroxythiophenol, 3-mercapto-1,2-propanediol, 1-mercapto-2-propanol, 2-mercaptopropionic acid, N-(2-mercaptopropionyl)glycine, 2-mercaptopyridinol, mercaptosuccinic acid, 2,3-dimercaptopropanesulfonic acid, 2,3-dimercaptopropanol, 2,3-dimercaptosuccinic acid, 2,5-dimercapto-1,3,4-thiadiazole, 3,4-toluenedithiol, o-, m-, and p-thiocresol, 2-mercaptoethylamine, ethylcyclohexanedithiol, p-menthane-2,9-dithiol and 1,2-ethanedithiol. Preferred functionalized end-capping agents include 2-mercaptoethanol, 3-mercapto-1,2-propanediol, 4-mercaptobutanol, 11-mercaptoundecanol, mercaptoacetic acid, 3-mercaptopropionic acid, 12-mercaptododecanoic acid, 2-mercaptoethylamine, 1-chloro-6-mercapto-4-oxahexan-2-ol, 2,3-dimercaptosuccinic acid, 2,3-dimercaptopropanol, 3-mercaptopropyltrimethoxysilane, 2-chloroethanethiol, 2-amino-3-mercaptopropionic acid, and compounds such as the adduct of 2-mercaptoethylamine and caprolactam.

Specific examples of fluorochemical functional compound co-reactants include: C₄F₉—SO₂NR²—CH₂CH₂OH; C₄F₉—SO₂NR²—CH₂CH₂—O-[CH₂CH₂O]ₜOH wherein t is 1 to 5; C₄F₉SO₂NR²CH₂CH₂CH₂NH₂; C₄F₉—SO₂NR²—CH₂CH₂SH; C₄F₉—SO₂NR²—(CH₂CH₂OH)₂; and C₄F₉—SO₂NR²—CH₂CH₂O(CH₂)ₙOH wherein s is 2 to 10 wherein R² is hydrogen or a lower alkyl of 1 to 4 carbons such as methyl, ethyl and propyl.

With respect to the co-reactants of Formula IV, it is preferred that the R_{f} groups thereof contain C₃ to C₆ perfluoroalkyl groups. It has been found that fluorochemical repellent additive having C₃-C₆ perfluoroalkyl groups provide repellency and/or antisoiling properties comparable to those provided by higher fluoroalkyl radicals. Heretofore it has been believed that perfluoroalkyl groups having at least 8 carbon atoms were necessary for adequate performance, and the performance of lower perfluoroalkyl groups degraded with decreasing carbon number. The performance of the present compositions are surprising in view of teachings that the lower perfluoroalkyl groups were significantly less effective than longer chain perfluoroalkyl groups, such as the perfluorooctyl group. For example, it has been demonstrated that surfactants derived from perfluorocarboxylic acids and perfluorosulfonic acids exhibit considerable differences in performance as a function of chain length. See, for example Organofluorine Chemicals and their Industrial Applications, edited by R. E. Banks, Ellis Horwood Ltd. (1979), p56; J. O. Hendrichs, Ind. Eng Chem., 45, 1953, p103; M. K. Bernett and W. A. Zisman, J. Phys. Chem., 63, 1959, p1912.

The fluorochemical repellent additive may further comprise, as the option co-reactant, the reaction product of one of more isocyanate blocking agents. The isocyanate blocking agent can be used alone or in combination with one or more other co-reactants described above. Isocyanate blocking agents are compounds that upon reaction with an isocyanate group yield a group that is unreactive at room temperature with compounds that at room temperature normally react with an isocyanate but which group at elevated temperature reacts with isocyanate reactive compounds. Generally, at elevated temperature the blocking group will be released from the blocked (poly)isocyanate compound thereby generating the isocyanate group again which can then react with an isocyanate reactive group. Blocking agents and their mechanisms have been described in detail in “Blocked isocyanates III.: Part. A, Mechanisms and chemistry” by Douglas Wicks and Zeno W. Wicks Jr., Progress in Organic Coatings, 36 (1999), pp. 14-172.

Preferred blocking agents include arylalcohols such as phenols, lactams such as ε-caprolactam, δ-valerolactam, γ-butyrolactam, oximes such as formaldoxime, acetaldoxime, cyclohexanone oxime, acetophenone oxime, benzophenone oxime, 2-butanone oxime or diethyl glyoxime. Further suitable blocking agents include bisulfite and triazoles.

The optional co-reactant may also comprise water, or a non-fluorinated organic compound having one or more isocyanate reactive functional groups. Examples include non-fluorinated organic compounds that have at least one or two functional groups that are capable of reacting with an isocyanate group. Such functional groups include hydroxy, amino and thiol groups. Examples of such organic compounds include aliphatic monofunctional alcohols, e.g., mono-alkanols having at least 1, preferably at least 6 carbon atoms, aliphatic monofunctional amines, a polyoxyalkylenes having 2, 3 or 4 carbon atoms in the oxyalkylene groups and having 1 or 2 groups having at least one isocyanate reactive functional groups, polyols including diols such as polyether diols, e.g., polytetramethylene glycol, polyester diols, dimer diols, fatty acid ester diols, polysiloxane diols and alkane diols such as ethylene glycol and polyamines.

Examples of monofunctional alcohols include methanol, ethanol, n-propyl alcohol, isopropyl alcohol, n-butyl alcohol, isobutyl alcohol, t-butyl alcohol, n-amyl alcohol, t-amyl alcohol, 2-ethylhexanol, glycidol and (iso)stearylalcohol.

Fatty ester diols are preferably diols that include an ester function derived from a fatty acid, preferably a fatty acid having at least 5 carbon atoms and more preferably at least 8 carbon atoms. Examples of fatty ester diols include glycerol mono-oleate, glycerol mono-stearate, glycerol mono-ricinoleate, glycerol mono-tallow, long chain alkyl di-esters of pentaerythritol having at least 5 carbon atoms in the alkyl group. Suitable fatty ester diols are commercially available under the brand RILANIT® from Henkel and examples include RILANIT® GMS, RILANIT® GMRO and RILANIT® HE.

Polysiloxane diols include polydialkylsiloxane diols and polyalkylarylsiloxane diols. The polymerization degree of the polysiloxane diol is preferably between 10 and 50 and more preferably between 10 and 30. Polysiloxane diols particularly include those that correspond to one of the following two formulas: 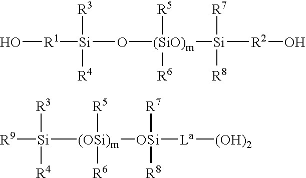
wherein R¹ and R² independently represent an alkylene having 1 to 4 carbon atoms, R³, R⁴, R⁵, R⁶, R⁷, R⁸ and R⁹ independently represent an alkyl group having 1 to 4 carbon atoms or an aryl group, La represents a trivalent linking group and m represents a value of 10 to 50. L is for example a linear or branched alkylene that may contain one or more catenary heteroatoms such as oxygen or nitrogen.

Further suitable diols include polyester diols. Examples include linear polyesters available under the brand UNIFLEX™ from Union Camp and polyesters derived from dimer acids or dimer diols. Dimer acids and dimer diols are well-known and are obtained by dimerisation of unsaturated acids or diols in particular of unsaturated long chain aliphatic acids or diols (e.g. at least 5 carbon atoms). Examples of polyesters obtainable from dimer acids and/or dimer diols are those available under the brand PRIPLAST from Uniqema, Gouda, Netherlands.

Dimer diols include those that are commercially available from Uniqema under the brand PRIPOL™ which are believed to have been obtained from dimerisation of unsaturated diols in particular of unsaturated long chain aliphatic diols (e.g., at least 5 carbon atoms).

In one embodiment, the repellent additive may include one or more water solubilizing groups or groups capable of forming water-solubilizing groups so as to obtain a repellent additive that can more easily be dispersed in water. This is particularly beneficial when dispersing the repellent additive in an aqueous adhesive emulsion prior to coating on a thermoplastic film. Suitable water solubilizing groups include cationic, anionic and zwitterionic groups as well as non-ionic water solubilizing groups. Examples of ionic water solubilizing groups include ammonium groups, phosphonium groups, sulfonium groups, carboxylates, sulfonates, phosphates, phosphonates or phosphinates. Examples of groups capable of forming a water-solubilizing group in water include groups that have the potential of being protonated in water such as amino groups, in particular tertiary amino groups. Particularly preferred organic compounds are those organic compounds that have only one or two functional groups capable of reacting with —NCO group and that further include a non-ionic water-solubilizing group.

Typical non-ionic water solubilizing groups include polyoxyalkylene groups. Preferred polyoxyalkylene groups include those having 1 to 4 carbon atoms such as polyoxyethylene, polyoxypropylene, polyoxytetramethylene and copolymers thereof such as polymers having both oxyethylene and oxypropylene units. The polyoxyalkylene containing organic compound may include one or two functional groups such as hydroxy or amino groups. Examples of polyoxyalkylene containing compounds include alkyl ethers of polyglycols such as e.g. methyl or ethyl ether of polyethyleneglycol, hydroxy terminated methyl or ethyl ether of a random or block copolymer of ethyleneoxide and propyleneoxide, amino terminated methyl or ethyl ether of polyethyleneoxide, polyethylene glycol, polypropylene glycol, a hydroxy terminated copolymer (including a block copolymer) of ethyleneoxide and propylene oxide, a diamino terminated poly(alkylene oxide) such as JEFFAMINE™ ED, JEFFAMINE™ EDR-148 and poly(oxyalkylene) thiols.

The condensation reaction to prepare the fluorochemical repellent additive can be carried out under conventional conditions well known to those skilled in the art. Preferably the reaction is run in the presence of a catalyst and typically, the reaction will be carried out such that all isocyanate groups have been reacted and the obtained reaction product is free of isocyanate groups. Suitable catalysts include tin salts such as dibutyltin dilaurate, stannous octanoate, stannous oleate, tin dibutyldi-(2-ethyl hexanoate), stannous chloride; and others known to those skilled in the art. The amount of catalyst present will depend on the particular reaction, and thus it is not practical to recite particular preferred concentrations. Generally, however, suitable catalyst concentrations are from about 0.001 percent to about 10 percent, preferably about 0.1 percent to about 5 percent, by weight based on the total weight of the reactants.

The condensation reaction is preferably carried out under dry conditions in a common organic solvent that are unreactive toward the reactive component of the reaction mixture, e.g. unreactive toward polyisocyanate, etc. Those skilled in the art based on the particular reagents, solvents, and catalysts being used will easily determine suitable reaction temperatures. While it is not practical to enumerate particular temperatures suitable for all situations, generally suitable temperatures are between about room temperature and about 120° C.

Generally the reaction is carried out such that between 1 and 100% of the isocyanate groups of the polyisocyanate compound or mixture of polyisocyanate compounds is reacted with the fluoroether compound according to formula (I). Preferably between 5 and 60% and more preferably 10% to 50% of the isocyanate groups is reacted with the perfluoroether compound and the remainder is reacted with one or more co-reactants as described above. In a preferred embodiment, 5 and 20% of the available isocyanate groups are reacted with the perfluoroalkyl functional compound of Formula IV. An especially preferred fluorochemical repellent additive is obtained by reacting 10 to 30% of the isocyanate groups with the perfluoroether compound according to formula (I), between 90 and 30% of the isocyanate groups with an isocyanate blocking agent and between 0 and 40% of the isocyanate groups with water or a non-fluorinated organic compound other than an isocyanate blocking agent.

The fluorochemical repellent additive typically will have a molecular weight not more than 100,000 g/mol, preferably not more than 50,000 g/mol with a typical range being between 1500 g/mol and 15,000 g/mol or between 1500 g/mol and 5,000 g/mol. When a mixture of fluorinated compounds is used, the aforementioned molecular weights represent weight average molecular weights.

It is particularly desirable when formulating with an adhesive to include one or more nonfluorinated surfactants which may enhance migration of the fluorochemical repellent additive and/or increase the repellency, and may be used to prepare stable fluorochemical an/or adhesive emulsions used in preparing the repellent articles. If used, one or more surfactants are generally added to the adhesive layer of the repellent article in an amount of at least about 0.05 wt-%, based on the total weight of the adhesive. Preferably, one or more surfactants are generally added in an amount of no greater than about 30 wt-%, more preferably no greater than about 20 wt-%, even more preferably no greater than about 10 wt-%, and most preferably no greater than about 5 wt-%, based on the total weight of the adhesive. Useful classes of surfactants include nonionic, anionic, cationic and amphoteric surfactants. Many of each type of surfactant are widely available to one skilled in the art. Accordingly, any surfactant or combination of surfactants may be employed. Such surfactants are also useful in making emulsion of the fluorochemical repellent additive prior to addition to the adhesive.

One useful class of nonionic surfactants include the condensation products of a higher aliphatic alcohol, such as a fatty alcohol, containing about 8 to about 20 carbon atoms, in a straight or branched chain configuration, condensed with about 3 to about 100 moles, preferably about 5 to about 40 moles, most preferably about 5 to about 20 moles of ethylene oxide. Examples of such nonionic ethoxylated fatty alcohol surfactants are the Tergitol™ 15-S series from Union Carbide and Brij™ surfactants from ICI. Tergitol™ 15-S Surfactants include C₁₁-C₁₅ secondary alcohol polyethyleneglycol ethers. Brij™97 surfactant is polyoxyethylene(10) oleyl ether; Brij™58 surfactant is polyoxyethylene(20) cetyl ether; and Brij™ 76 surfactant is polyoxyethylene(10) stearyl ether.

Another useful class of nonionic surfactants include the polyethylene oxide condensates of one mole of alkyl phenol containing from about 6 to 12 carbon atoms in a straight or branched chain configuration, with about 3 to about 100 moles, preferably about 5 to about 40 moles, most preferably about 5 to about 20 moles of ethylene oxide. Examples of nonreactive nonionic surfactants are the Igepal™ CO and CA series from Rhone-Poulenc. Igepal™CO surfactants include nonylphenoxy poly(ethyleneoxy) ethanols. Igepal™ CA surfactants include octylphenoxy poly(ethyleneoxy) ethanols.

Another useful class of nonionic surfactants includes block copolymers of ethylene oxide and propylene oxide or butylene oxide with HLB (hydrophilic/lipophilic balance) values of about 6 to about 19, preferably about 9 to about 18, and most preferably about 10 to about 16. Examples of such nonionic block copolymer surfactants (known as poloxamers) are the Pluronic™ and Tetronic™series of surfactants from BASF. Pluronic™ surfactants include ethylene oxide-propylene oxide block copolymers. Tetronic™ surfactants include ethylene oxide-propylene oxide block copolymers. A preferred example is Polaxamer™ 124 or Pluronic™ L44, which are liquids at room temperature and have HLB values of 12 to 18.

Still other useful nonionic surfactants include sorbitan fatty acid esters, polyoxyethylene sorbitan fatty acid esters and polyoxyethylene stearates having HLBs of about 6 to about 19, preferably about 9 to about 18, and most preferably about 10 to about 16. Examples of such fatty acid ester nonionic surfactants are the Span™, Tween™, and Myrj™ surfactants from ICI (now Uniqema). Span™ surfactants include C₁₂-C₁₈ sorbitan monoesters. Tween™ surfactants include poly(ethylene oxide) C₁₂-C₁₈ sorbitan monoesters. Myrj™ surfactants include poly(ethylene oxide) stearates.

Particularly suitable hydrocarbon nonionic surfactants include polyoxyethylene alkyl ethers, polyoxyethylene alkyl-phenyl ethers, polyoxyethylene acyl esters, sorbitan fatty acid esters, polyoxyethylene alkylamines, polyoxyethylene alkylamides, polyoxyethylene lauryl ether, polyoxyethylene cetyl ether, polyoxyethylene stearyl ether, polyoxyethylene oleyl ether, polyoxyethylene octylphenyl ether, polyoxyethylene nonylphenyl ether, polyethylene glycol laurate, polyethylene glycol stearate, polyethylene glycol distearate, polyethylene glycol oleate, oxyethylene-oxypropylene block copolymer, sorbitan laurate, sorbitan stearate, sorbitan distearate, sorbitan oleate, sorbitan sesquioleate, sorbitan trioleate, polyoxyethylene sorbitan laurate, polyoxyethylene sorbitan stearate, polyoxyethylene sorbitan oleate, polyoxyethylene laurylamine, polyoxyethylene laurylamide, laurylamine acetate, hard beef tallow propylenediamine dioleate, ethoxylated tetramethyldecynediol, fluoroaliphatic polymeric ester, polyether-polysiloxane copolymer, and the like.

Useful anionic surfactants include, but are not limited to, alkali metal and (alkyl)ammonium salts of: 1) alkyl sulfates and sulfonates such as sodium dodecyl sulfate and potassium dodecanesulfonate; 2) sulfates of polyethoxylated derivatives of straight or branched chain aliphatic alcohols and carboxylic acids; 3) alkylbenzene or alkylnaphthalene sulfonates and sulfates such as sodium laurylbenzene-sulfonate; 4) ethoxylated and polyethoxylated alkyl and aralkyl alcohol carboxylates; 5) glycinates such as alkyl sarcosinates and alkyl glycinates; 6) sulfosuccinates including dialkyl sulfosuccinates; 7) isothionate derivatives; 8) N-acyltaurine derivatives such as sodium N-methyl-N-oleyltaurate); 9) amine oxides including alkyl and alkylamidoalkyldialkylamine oxides; and 10) alkyl phosphate mono or di-esters such as ethoxylated dodecyl alcohol phosphate ester, sodium salt.

Representative commercial examples of suitable anionic sulfonate surfactants include, for example, sodium lauryl sulfate, available as TEXAPON™ L-100 from Henkel Inc., Wilmington, Del., or as POLYSTEP™ B-3 from Stepan Chemical Co, Northfield, Ill.; sodium 25 lauryl ether sulfate, available as POLYSTEP™ B-12 from Stepan Chemical Co., Northfield, Ill.; ammonium lauryl sulfate, available as STANDAPOL™ A from Henkel Inc., Wilmington, Del.; and sodium dodecyl benzene sulfonate, available as SIPONATE™ DS-10 from Rhone-Poulenc, Inc., Cranberry, N.J., dialkyl sulfosuccinates, having the tradename AEROSOL™ OT, commercially available from Cytec Industries, West Paterson, N.J.; sodium methyl taurate (available under the trade designation NIKKOL™ CMT30 from Nikko Chemicals Co., Tokyo, Japan); secondary alkane sulfonates such as Hostapur™ SAS which is a Sodium (C₁₄-C₁₇)secondary alkane sulfonates (alpha-olefin sulfonates) available from Clariant Corp., Charlotte, N.C.; methyl-2-sulfoalkyl esters such as sodium methyl-2-sulfo(C₁₂₋₁₆)ester and disodium 2-sulfo(C₁₂-C₁₆)fatty acid available from Stepan Company under the trade designation ALPHASTE™ PC-48; alkylsulfoacetates and alkylsulfosuccinates available as sodium laurylsulfoacetate (under the trade designation LANTHANOL™ LAL) and disodiumlaurethsulfosuccinate (STEPANMILD™ SL3), both from Stepan Company; alkylsulfates such as ammoniumlauryl sulfate commercially available under the trade designation STEPANOL™ AM from Stepan Company.

Representative commercial examples of suitable anionic phosphate surfactants include a mixture of mono-, di- and tri-(alkyltetraglycolether)-o-phosphoric acid esters generally referred to as trilaureth-4-phosphate commercially available under the trade designation HOSTAPHAT™ 340KL from Clariant Corp., as well as PPG-5 cetyl 10 phosphate available under the trade designation CRODAPHOS™ SG from Croda Inc., Parsipanny, N.J.

Representative commercial examples of suitable anionic amine oxide surfactants those commercially available under the trade designations AMMONYX™ LO, LMDO, and CO, which are lauryldimethylamine oxide, laurylamidopropyldimethylamine oxide, and cetyl amine oxide, all from Stepan Company.

Examples of useful amphoteric surfactants include alkyldimethyl amine oxides, alkylcarboxamidoalkylenedimethyl amine oxides, aminopropionates, sulfobetaines, alkyl betaines, alkylamidobetaines, dihydroxyethyl glycinates, imidazoline acetates, imidazoline propionates, ammonium carboxylate and ammonium sulfonate amphoterics and imidazoline sulfonates.

Representative commercial examples amphoteric surfactants include certain betaines such as cocobetaine and cocamidopropyl betaine (commercially available under the trade designations MACKAM™ CB-35 and MACKAM™ L from McIntyre Group Ltd., University Park, Ill.); monoacetates such as sodium lauroamphoacetate; diacetates such as disodium lauroamphoacetate; amino- and alkylamino-propionates such as lauraminopropionic acid (commercially available under the trade designations MACKAM 1L, MACKAM™ 2L, and MACKAM™ 151L, respectively, from McIntyre Group Ltd.) and cocamidopropylhydroxysultaine (commercially available as MACKAM™ 50-SB from McIntyre Group Ltd.).

Useful cationic surfactants include alkylammonium salts having the formula CₙH₂ₙ₊₁N(CH₃)₃X, where X is ⁻OH, ⁻Cl, ⁻Br, ⁻HSO₄ or a combination thereof, and where n is an integer from 8 to 22, and the formula CₙH₂ₙ₊₁N(CH₃)₃X, CₙH₂₊₁N(C₂H₅)₃X, where X is as previous described and where n is an integer from 12 to 18; gemini surfactants, for example those having the formula: [C₁₆H₃₃N(CH₃)₂ CₘH₂ₘ₊₁]X, wherein m is an integer from 2 to 12 and X is as defined above; aralkylammonium salts such as, for example, benzalkonium salts; and cetylethylpiperidinium salts, for example, C₆H₃₃N(C₂H₅)(C₅H₁₀)X, wherein X is as defined above.

Examples of suitable quaternary ammonium halide surfactants include, but are not limited to, trimethyl alkyl benzyl ammonium chloride, available as VARIQUAT™ 50MC from Witco Corp., Greenwich, Conn.; methylbis(2-hydroxyethyl)co-ammonium chloride or oleyl-ammonium chloride, available as ETHOQUAD™ C/12 and ETHOQUAD™ O/12, respectively, from Akzo Chemical Inc., Matawan, N.J.; and methyl polyoxyethylene octadecyl ammonium chloride, available as ETHOQUAD™ 18/25 from Akzo Chemical Inc., Matawan, N.J.

Examples of thermoplastic polymers for use in the thermoplastic polymer layer include polyesters, polyurethanes, polyamides and poly(alpha)olefins. Preferred thermoplastic polymers are poly(alpha)olefins. Poly(alpha)olefins can include the normally solid, homo-, co- and terpolymers of aliphatic mono-1-olefins (alpha olefins) as they are generally recognized in the art. Usually, the monomers employed in making such poly(alpha)olefins contain about 2 to 10 carbon atoms per molecule, though higher molecular weight monomers sometimes are used as co-monomers. The invention is applicable also to blends of the polymers and copolymers prepared mechanically or in situ. Examples of useful monomers that can be employed to prepare the thermoplastic polymers include ethylene, propylene, butene, pentene, 4-methyl-pentene, hexene, and octene, alone, or in admixture, or in sequential polymerization systems. Examples of preferred thermoplastic polymers include polyethylene, polypropylene, propylene/ethylene copolymers, polybutylene and blends thereof. Processes for preparing the thermoplastic polymers are well known, and the invention is not limited to a polymer made with a particular process.

The thermoplastic polymer layer may in the form of a film, membrane or fibrous layer and may be oriented or unoriented. As used herein, the terms “fiber” and “fibrous” refer to particulate matter, generally thermoplastic resin, wherein the length to diameter ratio of the particulate matter is greater than or equal to about 10. Fiber diameters may range from about 0.5 micrometers up to at least 1,000 micrometers. Each fiber may have a variety of cross-sectional geometries, may be solid or hollow, and may be colored by, e.g., incorporating dye or pigment into the polymer melt prior to extrusion. For purposes of this invention, a “film” is distinguished from a “membrane” in that any porosity present in a film does not transcend the entire thickness of the film, whereas at least some porosity present in a membrane does transcend the entire thickness of the membrane to provide a fluid conduit between opposing surfaces.

Useful fibrous thermoplastic polymer layers include woven, knitted, and nonwoven fabrics. The thermoplastic polymer layer may have any thickness, but typically, the thickness is in a range of from at least 10, 25, or 1000 micrometers up to and including 0.5, 2.5, or even 5 millimeters or more. The thermoplastic polymer layer may be a single layer, or may comprise multiple layers of the same of different thermoplastic polymers. In one embodiment, the repellent article may have a construction such as P¹P² . . . P^{Ω}A, where P¹, P2, to P^{Ω} represent thermoplastic polymer layers, and A represents an adhesive layer, having a repellent additive dispersed therein. Multilayer films can be made using a variety of equipment and a number of melt-processing techniques (typically, extrusion techniques) well known in the art. Such equipment and techniques are disclosed, for example, in U.S. Pat. No. 3,565,985 (Schrenk et al.), U.S. Pat. No. 5,427,842 (Bland et al.), U.S. Pat. No. 5,589,122 (Leonard et al.), U.S. Pat. No. 5,599,602 (Leonard et al.), and U.S. Pat. No. 5,660,922 (Herridge et al.).

The fibrous thermoplastic polymer layer may include non-woven webs manufactured by any of the commonly known processes for producing nonwoven webs. For example, the fibrous nonwoven web can be made by carded, air laid, spunlaced, spunbonding or melt-blowing techniques or combinations thereof. Spunbonded fibers are typically small diameter fibers that are formed by extruding molten thermoplastic polymer as filaments from a plurality of fine, usually circular capillaries of a spinneret with the diameter of the extruded fibers being rapidly reduced. Meltblown fibers are typically formed by extruding the molten thermoplastic material through a plurality of fine, usually circular, die capillaries as molten threads or filaments into a high velocity, usually heated gas (e.g. air) stream which attenuates the filaments of molten thermoplastic material to reduce their diameter. Thereafter, the meltblown fibers are carried by the high velocity gas stream and are deposited on a collecting surface to from a web of randomly disbursed meltblown fibers. Any of the non-woven webs may be made from a single type of fiber or two or more fibers that differ in the type of thermoplastic polymer and/or thickness.

Further details on the manufacturing method of non-woven webs of this invention may be found in Wente, Superfine Thermoplastic Fibers, 48 INDUS. ENG. CHEM. 1342(1956), or in Wente et al., Manufacture Of Superfine Organic Fibers, (Naval Research Laboratories Report No. 4364, 1954).

Where the polymer layer is a microporous membrane, the membranes have a structure that enables fluids to flow through them. The effective pore size is at least several times the mean free path of the flowing molecules, namely form several micrometers down to about 100 Angstroms. Such sheets are generally opaque, even when made of transparent material, because the surfaces and the internal structure scatter visible light.

There are several methods known in the art to prepare a microporous membranes. A preferred method for producing the microporous membranes of the present invention utilizes the phase separation phenomenon that utilizes either liquid-liquid or solid-liquid phase separation. The method for producing microporous structures using these techniques usually involves melt blending the polymer with a compatible liquid that is miscible with the polymer at the casting or extrusion temperature, forming a shaped article of the melt blend, and cooling the shaped article to a temperature at which the polymer phase separates from the compatible liquid. Microporosity can be imparted to the resultant structure by, for example, (i) orienting the structure in at least one direction; (ii) removing the compatible liquid and then orienting the structure in at least one direction; or (iii) orienting the structure in at least one direction and then removing the compatible liquid. The cooling step for films is usually accomplished by contacting the film with a chill roll. This results in a thin skin being formed on the side of the membranes that contacts the chill roll, which results in a decrease in the fluid flow through the film.

Such methods are described, for example, in U.S. Pat. No. 4,247,498 (Castro), U.S. Pat. No. 4,539,256 (Shipman), U.S. Pat. No. 4,726,989 (Mrozinski) and U.S. Pat. No. 4,867,881 (Kinzer). Particulate-filled microporous membranes such as those described in, for example, U.S. Pat. No. 4,777,073 (Sheth), U.S. Pat. No. 4,861,644 (Young et al.), and U.S. Pat. No. 5,176,953 (Jacoby et al.), as well as JP 61-264031 (Mitsubishi Kasei KK), can also be utilized. Microporosity can be imparted to such particulate-filled films by, for example, orienting the film in at least one direction.

The thermoplastic polymer layer, whether film, membrane or fibrous, may comprise a pattern of elevated areas or relatively thick portions, separated by valleys, or relatively thin portions. The elevated areas take the form of ridges, mounds, peaks, cylinders, grooves or other embossments which may be uniform or varied in shape and dimensions and are generally disposed in a regular arrangement or pattern. “Pattern” does not necessarily refer to a regular repeating array, but may mean a random array of features having the same or different sizes. Patterns suitable for the practice of this invention include four-sided square pyramids, truncated four-sided square pyramids, cones, straight lines, wavy lines, square or rectangular blocks, hemispheres, grooves and the like and are imparted to at least a portion of the thermoplastic polymer layer. An individual feature of the pattern is referred to as an embossment. The number and spacing of embossments, as well as the nature of the individual embossment, such as its depth, degree of sharp reflecting edges, and shape can be varied as well. The terms “pattern” and “embossment” are used without reference to the process of application.

A plurality of embossments may be formed on the thermoplastic polymer layer. There are typically about 5 to 20 embossments per lineal centimeter. The embossments can be of any suitable depth, as long as the mechanical properties of the films are sufficient for the desired end use after the embossments have been formed. The depth of an embossment typically ranges from 10 to about 90 percent of the thickness of the oriented thermoplastic film. Preferably, the depth of an embossment typically ranges from 25 to 75 percent of the thickness of the thermoplastic polymer.

Embossing refers to a process in which a pattern is impressed into the surface of an article. Embossing is typically accomplished by means of a male pattern formed on a hard material such as a metal layer on an embossing roll. Those skilled in the art recognize that embossing can be done by several methods, including the use of a continuous tooled belt or sleeve. Preferred metal layers include those comprising nickel, copper, steel, and stainless steel. Patterns are typically acid etched or machined into the metal layer and can have a wide variety of sizes and shapes. Any pattern that can be scribed into a metal surface can be used in the practice of this invention. One useful embossing method is described in Assignee's U.S. Pat. No. 6,514,597, (Strobel et al.), incorporated herein by reference.

Embossing can be carried out by any means known in the art. The preferred method of embossing is to move the softened thermoplastic polymer layer (prior to coating with the adhesive layer) through a nip having an embossing surface. “Nip” refers to two rolls in proximity that apply pressure on a film when the film passes between them. The embossing surface contacts the film with sufficient force to create embossments in the softened surface of the thermoplastic polymer layer. The embossed surface is then cooled by any of a number of methods to reduce the temperature of the softened surface to below its softening temperature before the article has experienced a significant change in bulk properties resulting from prior orientation. Such methods include moving the film over one or more chilled rollers, delivering it to a water bath, or cooling by air or other gases, such as by use of an air knife.

Any adhesive suitable for use with thermoplastic polymers, that can also serve as a reservoir for fluorochemical repellent additives, and that is non-reactive toward the fluorochemical repellent additives, can be used in the present invention. Adhesives can include hot melt adhesives, actinic radiation reactive adhesives, and the like. The adhesives can be solvent-based adhesives, 100% solids adhesives, or latex-based adhesives. Reference may be made to Handbook of Pressure Sensitive Adhesive Technology, Second Edition, D. Satas, Editor, Van Nostrand, Rheinhold, 1989. Preferably the adhesive is a pressure sensitive adhesive. “Pressure sensitive adhesive” means an adhesive that is aggressively and permanently tacky at room temperature and firmly adheres to a variety of dissimilar surfaces upon mere contact without the need of more than finger or hand pressure, and has a sufficiently cohesive holding to an adherend and removed from smooth surfaces without leaving a residue.

Suitable pressure sensitive adhesives include, for example, those based on natural rubbers, synthetic rubbers, styrene block copolymers, polyvinyl ethers, poly (meth)acrylates (including both acrylates and methacrylates), polyurethanes, polyureas, polyolefins, and silicones. The pressure sensitive adhesive may comprise an inherently tacky material, or if desired, tackifiers may be added to a tacky or non-tacky base material to form the pressure sensitive adhesive. Useful tackifiers include, for example, rosin ester resins, aromatic hydrocarbon resins, aliphatic hydrocarbon resins, and terpene resins. Other materials can be added for special purposes, including, for example, plasticizers, hydrogenated butyl rubber, glass beads, conductive particles, filler, dyes, pigments, and combinations thereof.

Pressure sensitive adhesives are commercially available from a number of sources including, for example, 3M Company, Saint Paul, Minn. Further examples of useful pressure sensitive adhesives include those generally described in U.S. Pat. No. 4,112,213 (Waldman); U.S. Pat. No. 4,917,928 (Heinecke); U.S. Pat. No. 4,917,929 (Heinecke); U.S. Pat. No. 5,141,790 (Calhoun); U.S. Pat. No. 5,045,386 (Stan et al.); U.S. Pat. No. 5,229,207 (Paquette et al.); U.S. Pat. No. 5,296,277 (Wilson et al.); U.S. Pat. No. 5,670,557 (Dietz et al.); and U.S. Pat. No. 6,232,366 (Wang et al.); the disclosures of which as incorporated herein by reference.

The adhesive may comprise removable or repositionable adhesives. A removable adhesive typically has a peel strength less than a conventional aggressively tacking PSA, for example a 180 degree peel strength (from a painted steel substrate employing a peel rate of 30.5 cm/min) of less than 8 N/cm, more particularly less than 6 N/cm. For purposes of this invention, an adhesive is considered to be “removable”, if after final application to an intended substrate the sheet material can be removed without damage to the substrate at the end of the intended life of the article at a rate in excess of 25 feet/hour (7.62 meters/hour) by hand with the optional use of heat. More preferably, the adhesive layer is a repositionable adhesive layer. For the purposes of this invention, “repositionable” refers to the ability to be, at least initially, repeatedly adhered to and removed from a substrate without substantial loss of adhesion capability. A repositionable adhesive usually has a peel strength, at least initially, to the substrate surface lower than that for a conventional aggressively tacky pressure sensitive adhesive.

Useful repositionable pressure sensitive adhesives include those described in U.S. Pat. No. 5,571,617 (Cooprider, et al.), entitled “Pressure Sensitive Adhesive Comprising Tacky Surface Active Microspheres”; or an adhesive from the class of adhesives based on solid inherently tacky, elastomeric microspheres, such as those disclosed in U.S. Pat. No. 3,691,140 (Silver), U.S. Pat. No. 3,857,731 (Merrill et al.), U.S. Pat. No. 4,166,152 (Baker et al.), although not limited to these examples.

The pressure sensitive adhesive layer may have any thickness. For example, the pressure sensitive adhesive layer may have a thickness in a range of from at least 25, 100, or 250 micrometers up to and including 500, 1000, or 2500 micrometers or even more.

Depending on the specific thermoplastic polymer layer chosen and intended application, the pressure sensitive adhesive layer may be selected such that, it cannot be mechanically separated from the thermoplastic polymer layer without damaging the thermoplastic polymer layer. This may be desirable, for example, in the case that two thermoplastic polymer layers are bonded together by the pressure sensitive adhesive layer.

The pressure sensitive adhesive layer may be continuous, for example, as a continuous adhesive film or a continuous or coating on fibers at one major surface of the fabric. Alternatively, the pressure sensitive adhesive layer can be a discontinuous layer. In one embodiment, the pressure sensitive adhesive layer may have the shape of an alphanumeric character or graphic image. Suitable methods for applying the pressure sensitive adhesive layer include, for example, roll coating, gravure coating, curtain coating, spray coating, screen printing, with the method typically chosen based on the type of coating desired.

The repellent article may further comprise an optional substrate that may be any solid material, and may have any shape. Suitable substrate materials include, for example, ceramics (e.g., tile, masonry), glass (e.g., windows), metal, cardboard, fabrics, and polymer films (e.g., coated or uncoated polymer films). More specifically, the substrate may be, for example, a motor vehicle, building, window, billboard, boat, wall, floor, door, or a combination thereof.

In one embodiment, the substrate may be a release liner, for example, to protect the adhesive before usage. Examples of release liners include silicone coated kraft paper, silicone coated polyethylene coated paper, silicone coated or non-coated polymeric materials such as polyethylene or polypropylene, as well as the aforementioned base materials coated with polymeric release agents such as silicone urea, urethanes, and long chain alkyl acrylates, such as generally described in U.S. Pat. No. 3,997,702 (Schurb et al.); U.S. Pat. No. 4,313,988 (Koshar et al.); U.S. Pat. No. 4,614,667 (Larson et al.); U.S. Pat. No. 5,202,190 (Kantner et al.); and U.S. Pat. No. 5,290,615 (Tushaus et al.); the disclosures of which are incorporated by reference herein. Suitable commercially available release liners include those available under the trade designation “POLYSLIK” from Rexam Release of Oakbrook, Ill., and under the trade designation “EXHERE” from P.H. Glatfelter Company of Spring Grove, Pa.

In another embodiment, the substrate may be a polymer layer which may be the same as, or different from, the first polymer layer. In this embodiment, the repellent article may be a multilayer repellent article having little or no tackiness on exterior surfaces. The resultant repellent article may be thus used, for example, for any use known for repellent articles, but will typically have increased repellency compared to the component thermoplastic polymers from which it is made. For example, a repellent article may be prepared by bonding two layers of thermoplastic polymer with pressure sensitive adhesive comprising at least 1 percent by weight of at least one fluorochemical repellent additive.

The repellent article may be prepared by combining the fluorochemical repellent additive and the adhesive and coating the mixture onto the thermoplastic polymer layer. The repellent additive and the pressure sensitive adhesive may be blended using any known mechanical means, such as shaking, stirring or mixing. In solvent- or emulsion-based adhesives, the adhesive is coated in an organic solvent and then dried. The adhesives (containing the fluorochemical repellent additive) may be coated by any variety of conventional coating techniques such as roll coating, spray coating, knife coating, die coating and the like.

The fluorochemical repellent additive is used in an amount sufficient to render the surface of the thermoplastic polymer layer repellent upon migration of the fluorochemical repellent additive. The fluorochemical repellent additive is typically used in an amount of at least about 1 wt. % based on the weight of the adhesive layer and more preferably in an amount of at least about 3 wt. %. The maximum amount of the fluorochemical repellent additive is not critical; however, in case of a repellent article consisting of only one layer of thermoplastic polymer, it is preferred to use the lowest amount possible so as not to impair the mechanical properties of the thermoplastic polymer layer. Generally, the amount of fluorochemical repellent additive is between about 1 wt. % and 45 wt. %, and more preferably between about 3 wt. % and 15 wt. %. If desired, the fluorochemical repellent additive may be added to the adhesive neat, as an emulsion or as a solution.

The repellent article is particularly useful as medical or surgical drapes, garments, protective films and barriers, carpet backings and outdoor fabrics.

As a barrier film, the article may be used in the installation of, or as a component of carpeting. The adhesive layer may be adhered to a foam pad of a carpet so that soils and spills do not soak into the foam. The thermoplastic polymer layer, in intimate contact with the carpeting may provide a renewable source of fluorochemical repellent additive, which may migrate from the adhesive to the thermoplastic film and into the carpet fibers, rendering them durably repellent.

In another embodiment, the article may provide a repellent surface for graphics, signage, and outdoor advertising, to render them resistant to water and graffiti. The article may be applied directly over the same by means of the adhesive layer.

In another embodiment, the article provides an easy-to-clean surface for floors, windows, furniture, counters, and workspaces in the form of films or sheets that may be adhered to the substrate surface and which will repel most soils. In one embodiment, the article may be used as a disposable work surface in any application where a readily cleaned surface is desirable. Such an article may be in the form of individual sheets, in a roll or in a set of stacked sheets. For example, a section of repellent article may be unwound from a roll and secured to a substrate with the adhesive layer. In another embodiment, the invention provides a plurality of articles in the form of a stack, such as an (PA)ₙ construction where P represents the thermoplastic polymer layer, A represents the adhesive layer, and n is greater than 1, e.g. 2 to 100. Individual articles may be removed from the stack and used as desired, or the stack per se may be secured to a substrate surface by means of the adhesive layer of the lowermost article. Fresh repellent surfaces may be provided by removal of the uppermost article. In such a stack, the surface of the thermoplastic polymer layer may be treated with a release layer to allow subsequent sheets to be removed from the stack, or the construction may provide a release liner between adjacent articles. Alternatively, such articles may be provided with a removable or repositionable adhesive. Such articles may be used, then disposed of when contaminated; ensuring a clean surface.

The invention is further illustrated by means of the following examples without the intention to limit the invention thereto.

### EXAMPLES

These examples are merely for illustrative purposes only and are not meant to be limiting on the scope of the appended claims. All parts, percentages, ratios, etc. in the examples and the rest of the specification are by weight, unless noted otherwise. Solvents and other reagents used were obtained from Aldrich Chemical Company; Milwaukee, Wis. unless otherwise noted.

Test Method

Surface Wetting Screening Test

This test is a qualitative measure of the surface wetting ability of a surface. A set volume of 10 microliters of one of the following: deionized water, isopropyl alcohol (IPA), solutions of water and IPA, or mineral oil were slowly deposited from a pipette directly onto the top surface of the material to be tested and observation was made whether the liquid droplet wets the surface or beads up during a period of up to 15 minutes. The results are presented as “Wets” if the droplet wets the surface or “Beads Up” if the droplet beads up on the surface.

Table of Abbreviations

| Abbreviation | |
|---|---|
| or Trade | |
| Designation | Description |
| Adhesive-1 | A water-based latex adhesive prepared generally according to the |
| | procedure described in WO 01/81491 A1 (Loncar), Examples 6 and 7, by |
| | blending: 42.7 parts by weight of a dispersion of hollow tacky |
| | microspheres prepared as generally described in WO 92/13924 |
| | (Steelman, et al.), Example 1; 48.8 parts of an acrylate pressure-sensitive |
| | adhesive commercially available from 3M Company, St. Paul, MN, |
| | under the trade designation FASTBOND 49; 0.9 part by weight of an |
| | acrylic resin solution available from Rohm & Haas Company, |
| | Philadelphia, PA, under the trade designation ACRYSOL ASE-60; 2.5 |
| | parts by weight of n-octanol; 5 parts by weight of a mixture of 58 parts of |
| | water, 3 parts of lithium hydroxide monohydrate, and 39 parts of |
| | ammonium hydroxide; and 0.1 part by weight of a defoamer available |
| | under the trade designation FOAMASTER JMY from Cognis Corp., |
| | Ambler, PA. |
| Additive-1 | Protective Chemical was prepared as described in U.S. 2004/0077238 for |
| | FC UR48. |
| Film-1 | A 15 micrometer thick extruded film of ESTANE 58237 thermoplastic |
| | polyurethane, available from Noveon, Inc., Cleveland, OH. |
| Film-2 | A 40 micrometer thick extruded film of HYTREL 4056 thermoplastic |
| | polyester elastomer, available from DuPont Engineering Polymers, |
| | Wilmington, DE. |
| Film-3 | CONTROLTAC PLUS Changeable Graphic Film 3500C, calendered |
| | polyvinyl chloride 100 micron thick, available from 3M Company, St. |
| | Paul, MN. |
| Fabric-1 | A spunbond nylon nonwoven fabric having a basis weight of 65 g/m² and |
| | a thickness of 0.15 mm (product number CEREX G066380), available |
| | from Western Nonwovens, Inc., Carson, CA. |
| Fabric-2 | A spunlaced PET/rayon (50/50) nonwoven fabric having a basis weight |
| | of 55 gsm, available from Green Bay Nonwovens, Inc., Green Bay, WI. |
| Fabric-3 | A woven PET/SPANDEX elastic fabric (Product Number SR 823) |
| | available from American Fiber and Finishing, Inc., Albemarle, NC. |
| Fabric-4 | Refers to a multicomponent fiber web having a basis weight of 100 g/m² |
| | and a thickness of 0.30 mm prepared by melt blown fiber production |
| | techniques according generally to the procedure of Backing Sample 16 in |
| | U.S. Pat. No. 6,107,219 (Joseph), the disclosure of which is |
| | incorporated herein by reference. The multicomponent fibers had a hot |
| | melt adhesive component (20 percent by weight) and a polyurethane |
| | component (80 percent by weight). |
| Fabric-5 | Nonwoven flashspun High Density Polyethylene fabric, Product Number |
| | TYVEK 1042B, having a basis weight of 40.7 g/m², available from E.I. |
| | du Pont de Nemours and Company, Wilmington, DE. |
| Microporous | A sample of a polypropylene based microporous membrane prepared by |
| Membrane | the thermally induced phase separation technique (U.S. Pat. No. 4,539,256 - |
| | Shipman et al., U.S. Pat. No. 4,726,989; U.S. Pat. No. 5,120,594 - Mrozinski). Sample was |
| | 144 micron thick, 40% porosity, and with 0.8 micrometer pore size |
| Liner-1 | PET release liner of with release agent on both sides, SCOTCHPAK |
| | TPK 6752 available from 3M Company, St. Paul, MN. |
| Liner-2 | PET liner HOSTAPHAN 4507 available from Mitsubishi Polyester Film |
| | Co., Tokyo, Japan. |
| PET | Poly(ethylene terephthalate) |
| Mineral Oil | Mineral oil Type NDC 0869-0831-43 available from Cumberland Swan, |
| | Inc., Smyrna, TN. |

### Example 1

Part I: Preparation of Adhesive Sample

A mixture of Adhesive-1 and 10% by weight of Additive-1 was prepared and coated at a thickness of 150 microns with a doctor knife onto Liner-1, and allowed to dry at room temperature for three days to give a dry adhesive thickness of approximately 60 microns. The final solids concentration of Additive-1 in the dried adhesive was approximately 8% by weight.

Part II: Preparation and Testing of Laminates

Two tapes of the adhesive sample prepared in Part I above were prepared by laminating adhesive samples to two samples of Film-1. The release liners were removed from each of these tapes and the adhesive sides of each tape was laminated to a glass slide to form a 3 layer laminate. One laminate was placed to age in an 85° C. oven, the second laminate was aged at room temperature. The sample laminates were tested daily for up to 9 days by the Surface Wetting Screening Test using the test method described above. The results are shown in Table 1.

### Comparative Example C1

Part I: Preparation of Adhesive Sample

Adhesive-1 with no additive was coated as described for Example 1, Part I above.

Part II: Preparation and Testing of Laminates

Two tapes of the adhesive sample prepared in Part I above were prepared by laminating adhesive samples to two samples of Film-1. The release liners were removed from each of these tapes and the adhesive sides of each tape was laminated to a glass slide to form a 3 layer laminate. One laminate was placed to age in an 85° C. oven, the second laminate was aged at room temperature. The sample laminates were tested daily for up to 9 days by the Surface Wetting Screening Test using the test method described above. The results are shown in Table 1.

### Example 2

Part I: Preparation of Adhesive Sample

A mixture of Adhesive-1 and 10% by weight of Additive-1 was prepared and coated at a thickness of 150 microns with a doctor knife onto Liner-1, and allowed to dry at room temperature for three days to give a dry adhesive thickness of approximately 60 microns. The final solids concentration of Additive-1 in the dried adhesive was approximately 8% by weight.

Part II: Preparation and Testing of Laminates

Two tapes of the adhesive sample prepared in Part I above were prepared by laminating adhesive samples to two samples of Fabric-1. The release liners were removed from each of these tapes and the adhesive sides of each tape was laminated to a glass slide to form a 3 layer laminate. One laminate was placed to age in an 85° C. oven, the second laminate was aged at room temperature. The sample laminates were tested daily for up to 27 days by the Surface Wetting Screening Test using the test method described above. The results are shown in Table 1.

### Comparative Example C2

Part I: Preparation of Adhesive Sample

Adhesive-1 with no additive was coated as described for Example 2, Part I above.

Part II: Preparation and Testing of Laminates

Two tapes of the adhesive sample prepared in Part I above were prepared by laminating adhesive samples to two samples of Fabric-1. The release liners were removed from each of these tapes and the adhesive sides of each tape was laminated to a glass slide to form a 3 layer laminate. One laminate was placed to age in an 85° C. oven, the second laminate was aged at room temperature. The sample laminates were tested daily for up to 27 days by the Surface Wetting Screening Test using the test method described above. The results are shown in Table 1.

### Example 3

Part I: Preparation of Adhesive Sample

A mixture of Adhesive-1 and 10% by weight of Additive-1 was prepared and coated at a thickness of 150 microns with a doctor knife onto Liner-1, and allowed to dry at room temperature for three days to give a dry adhesive thickness of approximately 60 microns. The final solids concentration of Additive-1 in the dried adhesive was approximately 8% by weight.

Part II: Preparation and Testing of Laminates

Two tapes of the adhesive sample prepared in Part I above were prepared by laminating adhesive samples to two samples of Fabric-2. The release liners were removed from each of these tapes and the adhesive sides of each tape was laminated to a glass slide to form a 3 layer laminate. One laminate was placed to age in an 85° C. oven, the second laminate was aged at room temperature. The sample laminates were tested daily for up to 27 days by the Surface Wetting Screening Test using the test method described above. The results are shown in Table 1.

### Comparative Example C3

Part I: Preparation of Adhesive Sample

Adhesive-1 with no additive was coated as described for Example 3, Part I above.

Part II: Preparation and Testing of Laminates

Two tapes of the adhesive sample prepared in Part I above were prepared by laminating adhesive samples to two samples of Fabric-2. The release liners were removed from each of these tapes and the adhesive sides of each tape was laminated to a glass slide to form a 3 layer laminate. One laminate was placed to age in an 85° C. oven, the second laminate was aged at room temperature. The sample laminates were tested daily for up to 27 days by the Surface Wetting Screening Test using the test method described above. The results are shown in Table 1.

### Example 4

Part I: Preparation of Adhesive Sample

A mixture of Adhesive-1 and 10% by weight of Additive-1 was prepared and coated at a thickness of 150 microns with a doctor knife onto Liner-1, and allowed to dry at room temperature for three days to give a dry adhesive thickness of approximately 60 microns. The final solids concentration of Additive-1 in the dried adhesive was approximately 8% by weight.

Part II: Preparation and Testing of Laminates

Two tapes of the adhesive sample prepared in Part I above were prepared by laminating adhesive samples to two samples of Fabric-3. The release liners were removed from each of these tapes and the adhesive sides of each tape was laminated to a glass slide to form a 3 layer laminate. One laminate was placed to age in an 85° C. oven, the second laminate was aged at room temperature. The sample laminates were tested daily for up to 27 days by the Surface Wetting Screening Test using the test method described above. The results are shown in Table 1.

### Comparative Example C4

Part I: Preparation of Adhesive Sample

Adhesive-1 with no additive was coated as described for Example 4, Part I above.

Part II: Preparation and Testing of Laminates

Two tapes of the adhesive sample prepared in Part I above were prepared by laminating adhesive samples to two samples of Fabric-3. The release liners were removed from each of these tapes and the adhesive sides of each tape was laminated to a glass slide to form a 3 layer laminate. One laminate was placed to age in an 85° C. oven, the second laminate was aged at room temperature. The sample laminates were tested daily for up to 27 days by the Surface Wetting Screening Test using the test method described above. The results are shown in Table 1.

### Example 5

Part I: Preparation of Adhesive Sample

A mixture of Adhesive-1 and 10% by weight of Additive-1 was prepared and coated at a thickness of 200 microns with a doctor knife onto Liner-2, and allowed to dry at room temperature for two days to give a dry adhesive thickness of approximately 80 microns. The final solids concentration of Additive-1 in the dried adhesive was approximately 8% by weight.

Part II: Preparation and Testing of Laminates

Two tapes of the adhesive sample prepared in Part I above were prepared by laminating adhesive samples to two samples of Fabric-4. One laminate was placed to age in an 85° C. oven; the second laminate was aged at room temperature. The sample laminates were tested frequently for up to 9 days by the Surface Wetting Screening Test using the test method described above. The results are shown in Table 1.

### Comparative Example C5

Part I: Preparation of Adhesive Sample

Adhesive-1 with no additive was coated as described for Example 5, Part I above.

Part II: Preparation and Testing of Laminates

Two tapes of the adhesive sample prepared in Part I above were prepared by laminating adhesive samples to two samples of Fabric-4. One laminate was placed to age in an 85° C. oven; the second laminate was aged at room temperature. The sample laminates were tested frequently for up to 9 days by the Surface Wetting Screening Test using the test method described above. The results are shown in Table 1.

### Example 6

Part I: Preparation of Adhesive Sample

A mixture of Adhesive-1 and 10% by weight of Additive-1 was prepared and coated at a thickness of 200 microns with a doctor knife onto Liner-2, and allowed to dry at room temperature for two days to give a dry adhesive thickness of approximately 80 microns. The final solids concentration of Additive-1 in the dried adhesive was approximately 8% by weight.

Part II: Preparation and Testing of Laminates

Two tapes of the adhesive sample prepared in Part I above were prepared by laminating adhesive samples to two samples of Fabric-5. One laminate was placed to age in an 85° C. oven; the second laminate was aged at room temperature. The sample laminates were tested frequently for up to 4 days by the Surface Wetting Screening Test using the test method described above. The results are shown in Table 1.

### Comparative Example C6

Part I: Preparation of Adhesive Sample

Adhesive-1 with no additive was coated as described for Example 6, Part I above.

Part II: Preparation and Testing of Laminates

Two tapes of the adhesive sample prepared in Part I above were prepared by laminating adhesive samples to two samples of Fabric-5. One laminate was placed to age in an 85° C. oven; the second laminate was aged at room temperature. The sample laminates were tested frequently for up to 4 days by the Surface Wetting Screening Test using the test method described above. The results are shown in Table 1.

### Example 7

Part I: Preparation of Adhesive Sample

A mixture of Adhesive-1 and 10% by weight of Additive-1 was prepared and coated at a thickness of 200 microns with a doctor knife onto Liner-2, and allowed to dry at room temperature for two days to give a dry adhesive thickness of approximately 80 microns. The final solids concentration of Additive-1 in the dried adhesive was approximately 8% by weight.

Part II: Preparation and Testing of Laminates

Two tapes of the adhesive sample prepared in Part I above were prepared by laminating adhesive samples to two samples of Film-2. One laminate was placed to age in an 85° C. oven; the second laminate was aged at room temperature. The sample laminates were tested frequently for up to 4 days by the Surface Wetting Screening Test using the test method described above. The results are shown in Table 1.

### Comparative Example C7

Part I: Preparation of Adhesive Sample

Adhesive-1 with no additive was coated as described for Example 7, Part I above.

Part II: Preparation and Testing of Laminates

Two tapes of the adhesive sample prepared in Part I above were prepared by laminating adhesive samples to two samples of Film-2. One laminate was placed to age in an 85° C. oven; the second laminate was aged at room temperature. The sample laminates were tested frequently for up to 4 days by the Surface Wetting Screening Test using the test method described above. The results are shown in Table 1.

### Example 8

Part I: Preparation of Adhesive Sample

A mixture of Adhesive-1 and 10% by weight of Additive-1 was prepared and coated at a thickness of 200 microns with a doctor knife onto Liner-2, and allowed to dry at room temperature for two days to give a dry adhesive thickness of approximately 80 microns. The final solids concentration of Additive-1 in the dried adhesive was approximately 8% by weight.

Part II: Preparation and Testing of Laminates

Two tapes of the adhesive sample prepared in Part I above were prepared by laminating adhesive samples to two samples of Film-3. One laminate was placed to age in an 85° C. oven; the second laminate was aged at room temperature. The sample laminates were tested frequently for up to 9 days by the Surface Wetting Screening Test using the test method described above. The results are shown in Table 1.

### Comparative Example C8

Part I: Preparation of Adhesive Sample

Adhesive-1 with no additive was coated as described for Example 8, Part I above.

Part II: Preparation and Testing of Laminates

Two tapes of the adhesive sample prepared in Part I above were prepared by laminating adhesive samples to two samples of Film-3. One laminate was placed to age in an 85° C. oven; the second laminate was aged at room temperature. The sample laminates were tested frequently for up to 9 days by the Surface Wetting Screening Test using the test method described above. The results are shown in Table 1.

### Example 9

Part I: Preparation of Adhesive Sample

A mixture of Adhesive-1 and 10% by weight of Additive-1 was prepared and coated at a thickness of 200 microns with a doctor knife onto Liner-2, and allowed to dry at room temperature for two days to give a dry adhesive thickness of approximately 80 microns. The final solids concentration of Additive-1 in the dried adhesive was approximately 8% by weight.

Part II: Preparation and Testing of Laminates

Two tapes of the adhesive sample prepared in Part I above were prepared by laminating adhesive samples to two samples of Microporous Membrane. One laminate was placed to age in an 85° C. oven; the second laminate was aged at room temperature. The sample laminates were tested frequently for up to 9 days by the Surface Wetting Screening Test using the test method described above. The results are shown in Table 1.

### Comparative Example C9

Part I: Preparation of Adhesive Sample

Adhesive-1 with no additive was coated as described for Example 9, Part I above.

Part II: Preparation and Testing of Laminates

Two tapes of the adhesive sample prepared in Part I above were prepared by laminating adhesive samples to two samples of Microporous Membrane. One laminate was placed to age in an 85° C. oven; the second laminate was aged at room temperature. The sample laminates were tested frequently for up to 9 days by the Surface Wetting Screening Test using the test method described above. The results are shown in Table 1.

TABLE 1

| | | | Aging | |
|---|---|---|---|---|
| Ex- | | Aging | Time | Surface |
| ample | Test Liquid | Temperature [° C.] | [days] | Wetting |
| 1 | Deionized Water | Room Temperature | 9 | Beaded Up |
| 1 | Deionized Water | 85° C. | 9 | Beaded Up |
| C1 | Deionized Water | Room Temperature | 9 | Beaded Up |
| C1 | Deionized Water | 85° C. | 9 | Beaded Up |
| 2 | Deionized Water | Room Temperature | 27 | Wets |
| 2 | Deionized Water | 85° C. | 6 | Beaded Up |
| C2 | Deionized Water | Room Temperature | 27 | Wets |
| C2 | Deionized Water | 85° C. | 27 | Wets |
| 3 | Deionized Water | Room Temperature | 27 | Wets |
| 3 | Deionized Water | 85° C. | 16 | Beads Up |
| C3 | Deionized Water | Room Temperature | 27 | Wets |
| C3 | Deionized Water | 85° C. | 27 | Wets |
| 4 | Deionized Water | Room Temperature | 27 | Wets |
| 4 | Deionized Water | 85° C. | 27 | Wets |
| C4 | Deionized Water | Room Temperature | 27 | Wets |
| C4 | Deionized Water | 85° C. | 27 | Wets |
| 5 | 80/20 Water/IPA | Room Temperature | 9 | Wets |
| | solution | | | |
| 5 | 80/20 Water/IPA | 85° C. | 7 | Beads Up |
| | solution | | | |
| C5 | 80/20 Water/IPA | Room Temperature | 9 | Wets |
| | solution | | | |
| C5 | 80/20 Water/IPA | 85° C. | 7 | Wets |
| | solution | | | |
| 6 | 80/20 Water/IPA | Room Temperature | 4 | Wets Slowly |
| | solution | | | |
| 6 | 80/20 Water/IPA | 85° C. | 4 | Beads Up |
| | solution | | | |
| C6 | 80/20 Water/IPA | Room Temperature | 4 | Wets |
| | solution | | | |
| C6 | 80/20 Water/IPA | 85° C. | 4 | Wets |
| | solution | | | |
| 7 | 90/10 Water/IPA | Room Temperature | 4 | Wets |
| | solution | | | |
| 7 | 90/10 Water/IPA | 85° C. | 4 | Beads Up |
| | solution | | | |
| C7 | 90/10 Water/IPA | Room Temperature | 4 | Wets |
| | solution | | | |
| C7 | 90/10 Water/IPA | 85° C. | 4 | Wets |
| | solution | | | |
| 8 | Isopropyl Alcohol | Room Temperature | 9 | Wets |
| 8 | Isopropyl Alcohol | 85° C. | 7 | Wets |
| C8 | Isopropyl Alcohol | Room Temperature | 9 | Wets |
| C8 | Isopropyl Alcohol | 85° C. | 7 | Wets |
| 9 | 80/20 Water/IPA | Room Temperature | 4 | Beads Up |
| | solution | | | |
| 9 | 80/20 Water/IPA | 85° C. | 1 | Beads Up |
| | solution | | | |
| 9 | Mineral Oil | Room Temperature | 9 | Wets |
| 9 | Mineral Oil | 85° C. | 9 | Wets |
| C9 | 80/20 Water/IPA | Room Temperature | 4 | Wets |
| | solution | | | |
| C9 | 80/20 Water/IPA | 85° C. | 1 | Wets |
| | solution | | | |
| C9 | Mineral Oil | Room Temperature | 9 | Wets |
| C9 | Mineral Oil | 85° C. | 9 | Wets |

We claim:

1. A repellent article comprising:
at least one thermoplastic polymer layer having a first surface and a second surface having an adhesive layer bonded to said second surface, said adhesive layer comprising a fluorochemical repellent additive that migrates to said first surface of said thermoplastic polymeric layer, said fluorochemical repellent additive comprising the reaction product of:
a) a fluorinated polyether according to the formula:
R_{f}Q-Tₖ (I)
wherein R_{f} represents a monovalent perfluorinated polyether group, Q represents a chemical bond or a divalent or trivalent organic linking group, T represents a functional group capable of reacting with an isocyanate and k is 1 or 2;
b) a polyisocyanate; and
c) optionally one or more co-reactants capable of reacting with an isocyanate group.

2. The repellent article of claim 1, wherein said optional co-reactant is of the formula:
(R_{f}⁴)ₓ-L-(Y)_{y}
wherein R_{f}⁴ represents a perfluoroalkyl group, L represents a non-fluorinated organic divalent or multi-valent linking group; Y represents an isocyanate-reactive functional group, x is 1 to 20, and y is 1 to 3.

3. The repellent article of claim 1, wherein said polyisocyanate comprises blocked isocyanate groups.

4. The repellent article of claim 2, wherein R_{f}⁴ is a perfluoroalkyl group of 3 to 6 carbon atoms.

5. The repellent article of formula 1, wherein R_{f} represent a perfluoropolyether group of the formula:
R_{f}¹—O—R_{f}²—(R_{f}³)_{q}-
wherein R_{f}¹ represents a perfluorinated alkyl group, R_{f}² represents a perfluorinated poly(alkyleneoxy) group consisting of perfluoroalkyleneoxy groups having 1 to 4 carbon atoms or a mixture thereof, and R_{f}³ represents a perfluorinated alkylene group and q is 0 or 1.

6. The repellent article of claim 1 wherein said polymeric layer comprises films, porous membranes, microporous membranes, and fibrous polymer layers.

7. The repellent article of claim 1 wherein said fluorochemical repellent additive is present in an amount sufficient to provide said thermoplastic polymer layer with and advancing water contact angle of 85° or greater.

8. The repellent article of claim 1 wherein said fluorochemical repellent additive is present in an amount sufficient to provide said thermoplastic polymer layer with and advancing contact oil angle of 50° or greater.

9. The repellent article of claim 1 wherein said adhesive layer comprises at least 1 wt. % of said fluorochemical repellent additive.

10. The repellent article of claim 1 wherein said adhesive layer comprises 3 to 15 wt. % of said fluorochemical repellent additive.

11. The repellent article of claim 1 wherein said polymeric layer is selected from polyesters, polyurethanes, polyamides and poly(alpha)olefins

12. The repellent article of claim 1 wherein said polymeric layer is selected from homo-, co- and terpolymers of aliphatic mono-alpha olefins.

13. The repellent article of claim 1 wherein said polymeric layer is selected from homo-, co- and terpolymers of ethylene and propylene.

14. The repellent article of claim 1, wherein said adhesive layer is a pressure sensitive adhesive layer.

15. The repellent article of claim 14 further comprising a release liner in contact with said pressure sensitive adhesive layer.

16. The repellent article of claim 1, wherein said fluorochemical repellent additive dispersed in said adhesive comprises a delivery system to facilitate the migration of such additives from the adhesive layer into adjoining thermoplastic polymer layer, and provide for replenishment of the additive.

17. The repellent article of claim 1, wherein said fluorochemical repellent additive has a diffusion constant of greater than 10×10⁻¹⁰ cm²/s at 25° C. in said thermoplastic polymer layer.

18. The repellent article of claim 1, wherein said fluorochemical repellent additive has a diffusion constant of greater than 100×10⁻¹⁰ cm²/s at 25° C. in said thermoplastic polymer layer.

19. The repellent article of claim 1, further comprising a non-fluorochemical surfactant dispersed in said adhesive layer.

20. A method of preparing a repellent article according to claim 1 comprising coating a thermoplastic polymer layer with an adhesive layer, said adhesive layer comprising a fluorochemical repellent additive that comprises a delivery system to facilitate the migration of such repellent additives from the adhesive layer into adjoining thermoplastic polymer layer, and provide for replenishment of the additive agent, said repellent additive comprising the reaction product of:
a) a fluorinated polyether according to the formula:
R_{f}-Q-Tₖ (I)
wherein R_{f} represents a monovalent perfluorinated polyether group, Q represents a chemical bond or a divalent or trivalent organic linking group, T represents a functional group capable of reacting with an isocyanate and k is 1 or 2;
b) a polyisocyanate; and
c) optionally one or more co-reactants capable of reacting with an isocyanate group.

21. The method of claim 20 wherein said thermoplastic polymer layer comprises a film, a membrane, or a fibrous polymer layer.

22. The method of claim 20 wherein said fluorochemical repellent additive is present in an amount sufficient to provide said thermoplastic polymer layer with an advancing water contact angle of 85° or greater and/or an advancing contact oil angle of 50° or greater.

23. The method of claim 20 wherein said adhesive layer comprises at least 1 wt. % of said fluorochemical repellent additive.
